(19) United States
(12) Patent Application Publication
(10) Pub. No.: US 2009/0038704 A1
(43) Pub. Date: Feb. 12, 2009

(54) Motor Vehicle Pipeline and Method for the Manufacturing of a Motor Vehicle Pipeline

(76) Inventors: Andreas Sausner, Frankfurt (DE); Gerhard Stanzl, Waibstadt (DE); Jacek Giemza, Karlsruhe (DE)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(21) Appl. No.: 12/139,122

(22) Filed: Jun. 13, 2008

(30) Foreign Application Priority Data
Jun. 13, 2007 (EP) 07 011 557.1
May 30, 2008 (EP) 08 009 935.1

(51) Int. Cl. F16L 9/14; C23C 2/28; C23C 2/12

(52) U.S. Cl. 138/143; 427/398.1; 427/431; 138/146

(57) ABSTRACT

Motor vehicle pipeline comprising a metal tube with an aluminum layer is applied to the outer surface of the metal tube. An aluminum oxide layer is present on the outer surface of the aluminum layer. The aluminum oxide layer forms the outer layer of the motor vehicle pipeline. A method of making the motor vehicle pipeline is disclosed.

### CROSS-REFERENCE TO RELATED APPLICATIONS

This application claims priority to European Patent Application No. 07 011 557.1, filed Jun. 13, 2007 and European Patent Application No. 08 009 935.1, filed May 30, 2008, both of which are hereby incorporated by reference in their entirety.

### BACKGROUND OF THE INVENTION

The invention relates to a motor vehicle pipeline comprising a metal tube with an aluminum layer on the outer surface of the metal tube. The invention relates in addition to a method for the manufacturing of such a motor vehicle pipeline. The motor vehicle pipeline is denoted in the following in brief as pipeline.

Motor vehicle pipelines are generally known. These known motor vehicle pipelines have in general usually at least one plastic layer that is arranged on the aluminum layer and that normally also forms the outer layer of the motor vehicle pipeline and serves for, among other things, the protection against corrosion and abrasions of the line. Many from practice known motor vehicle pipelines must be manufactured in a relatively expensive manner.

### BRIEF SUMMARY OF THE INVENTION

The invention is based on the technical problem of specifying a motor vehicle pipeline of the type mentioned in the beginning that can be manufactured relatively simply and at little cost and that nevertheless guarantees an optimal corrosion protection. In addition, the invention is based on the technical problem to specify a method for the manufacturing of such a motor vehicle pipeline.

To solve the technical problem, the invention teaches a motor vehicle pipeline comprising a metal tube with an aluminum layer on the outer surface of the metal tube with an aluminum oxide layer arranged as the outer surface layer of the aluminum layer, whereby this aluminum oxide layer forms the outer layer of the motor vehicle pipeline.—Aluminum oxide means in the context of the invention AlxOy and in particular Al2O3.

The metal tube can be a single-walled metal tube (single wall tube) or a double-wall metal tube (double wall tube). It is within the framework of the invention that the metal tube is a steel tube. The steel tube is advantageously manufactured by rolling a steel band that can be coated with an additional layer of another metal on one or both sides.—The aluminum layer is, according to a particularly preferred embodiment of the invention, applied by a hot-dip method. It is in the framework of the invention that the aluminum oxide layer is the outer layer of the motor vehicle pipeline. This means in particular that advantageously no additional layer or plastic layer is applied to the outer aluminum oxide layer.

According to a first preferred embodiment of the invention, the outer surface of the metal tube, in particular a steel tube, is an uncoated metal surface, in particular an uncoated steel surface. The aluminum layer is then directly, and without the interposition of an additional layer, applied to the metal surface or steel surface of the metal tube. According to a preferred embodiment variant, the metal tube is a double-rolled metal tube/steel tube (double wall tube). This double-rolled tube is advantageously manufactured from a metal band or a steel band that is preferably coated on only one side with copper. For the manufacturing of the tube a rolling-up of the band takes place and preferably a soldering of the two layers of double-rolled tube with the aid of the copper layer. This results in a metal tube/steel tube that is uncoated on its outside, i.e., a metal tube/steel tube with an uncoated metal outer surface/steel outer surface. In this first embodiment of the invention, the aluminum layer is directly applied to the uncoated metal surface/steel surface. It can thereby also involve the uncoated metal outside/steel outside of a single-walled tube (single wall tube).

According to a second embodiment of the invention, a nickel layer is arranged between the outer surface of the metal tube and the aluminum layer. The nickel layer is thereby advantageously applied to the outer surface of the metal tube forming an uncoated metal surface/steel surface and the aluminum layer is then preferably applied directly to this nickel layer. The application of the aluminum layer here also preferably takes place according to the hot-dip method.

According to a preferred embodiment of the invention, the nickel layer is initially applied on one side to the uncoated metal surface/steel surface of a metal band or steel band that is subsequently rolled into a single-walled or double-walled metal tube/steel tube, so that the nickel layer forms the outside surface of the rolled tube. It is within the framework of the invention that a corresponding single-walled metal tube/steel tube is longitudinally welded.—Basically, the nickel layer can also be applied to the uncoated metal surface/steel surface of the cylindrical metal tube/steel tube.—Preferably, the aluminum coating is applied directly to the nickel coated outer surface of the single-walled or double-walled metal tube/steel tube and namely preferably with the hot-dip method.

When, according to an embodiment variant of the invention, it involves a double-walled metal tube/steel tube, it is preferably manufactured by rolling a metal band/steel band that is coated on one side with copper and is advantageously coated on the other side with nickel. It is within the framework of the invention that a rolling up of the band and preferably a soldering of both the layers of the double-walled metal tube/steel tube takes place, whereby the nickel coating is arranged on the outer surface of the double-walled metal tube. This aluminum layer is advantageously applied directly to the nickel layer and namely preferably with the hot-dip method.

According to an additional recommended embodiment variant, a copper layer is provided on the outer surface of the metal tube, so that this copper layer is arranged between the metal tube and the aluminum layer. It is thereby within the framework of the invention that the copper layer is provided directly, i.e., without the interposition of an additional layer, on the outer surface of the metal tube. The metal tube can also in this embodiment variant be constructed to be single-walled or double-walled. A nickel layer or the, in the preceding already explained, nickel layer is preferably arranged between the copper layer and the aluminum layer. The nickel layer thereby advantageously borders directly to the copper layer on one side and directly to the aluminum layer on the other side, i.e., without the interposition of additional layers. The thickness of the copper layer is preferably 50 to 300 nm, preferentially 50 to 200 nm, very preferentially 50 to 150 nm, and particularly preferentially 70 to 130 nm. When the metal tube involves a double-walled metal tube/steel tube, it is preferably manufactured by rolling a metal band/steel band that according to recommendation is coated on both sides with copper. The aluminum coating is preferably applied with the hot-dip method also in the embodiment variant with a copper layer that is applied to the external surface of the metal tube. (nm means nanometer)

The invention is based on the recognition that the aluminum layer, especially the aluminum layer that is applied with the hot-dip method, adheres optimally to an uncoated steel surface on the outside of the metal tube as well as to a, with a nickel layer provided, outer surface of the metal tube/steel tube.

In the case that a nickel layer is applied to the outer surface of the metal tube or the, on the outer surface arranged, copper layer, the thickness of this nickel layer is advantageously 0.2 to 50 μm, preferably 0.2 to 10 μm, and preferentially 0.2 to 5 μm. According to a particularly preferred embodiment of the invention the thickness of the nickel layer is less than 5 μm and very preferentially less than 4 μm. A particularly recommended embodiment of the invention is characterized by the fact that the thickness of the nickel layer ranges from 0.2 to 3 μm, preferably from 0.3 to 2.5 μm, and particularly preferably from 0.3 to 1.5 μm.

It is within the framework of the invention that the thickness of the aluminum layer is less than 250 μm. The thickness of the aluminum layer is advantageously 10 to 200 μm, preferably 20 to 180 μm, preferentially 25 to 150 μm, and particularly preferentially 30 to 150 μm. According to recommendation the thickness of the aluminum layer lies in the range of 40 to 150 μm, preferably 50 to 150 μm, preferentially 80 to 150 μm, and particularly preferentially 90 to 140 μm. The thickness of the aluminum layer, by the way, means the thickness of the metallic aluminum layer (without aluminum oxide layer).

The outer surface of the motor vehicle pipeline is formed according to the invention by an aluminum oxide layer. It is thereby within the framework of the invention that the aluminum oxide layer is located directly on the aluminum layer, namely without the interposition of other layers. The thickness of the aluminum oxide layer is advantageously 4 to 30 nm, preferably 5 to 25 nm and particularly preferentially 6 to 20 nm. Aluminum oxide layer means in the context of the invention in particular a layer that contains more than 20 at % oxygen.

According to a recommended embodiment of the invention, the roundness of the outer contour of the pipeline is maximally 500 μm, preferably maximally 400 μm, preferentially maximally 300 μm, and particularly preferentially maximally 200 μm. It is especially recommended that the roundness of the pipeline is maximally 170 μm. The roundness of the outer contour of the pipeline is thereby defined as the difference in the diameter of two concentric circles, of which one has the largest possible inner circle and the other the smallest possible outer circle and the outer contour of the pipeline is completely accommodated between these circles. In other words, the periphery of the outer contour of all cross-sections of the pipeline must lie completely within a tolerance range that is determined by the two mentioned concentric circles. Compliance with the above specified roundness of the outer contour contributes in a surprising manner to the solution of the technical problem and to the mechanical resistance of the pipeline and its layer structure.

The outer layer of the pipeline means in the following the layer or the whole layer formed by the aluminum layer and the aluminum oxide layer. According to recommendation, the thickness variation of the outer layer is maximally 100 μm, preferably maximally 80 μm, preferentially maximally 60 μm, very preferentially maximally 50 μm, and particularly preferentially maximally 40 μm. Layer thickness variation means the difference between a maximum layer thickness of the outer layer and a minimum layer thickness of the outer layer in a cross section of the tube. Compliance with the in the preceding described layer thickness variation has, with respect to the solution of the technical problem, proven itself in a surprising way and also with respect to the bond strength of the layers of pipeline.

A particularly preferred embodiment of the invention is characterized by that the average roughness Ra of the external surface of the pipeline is advantageously less than 8 μm, preferably less than 7 μm, preferentially less than 6.8 μm, very preferentially less than 6.5 μm, and particularly preferentially less than 6 μm. The average roughness Ra is defined as the arithmetic mean of the absolute values of ordinate coordinate of the roughness profile (DIN EN ISO 4287, the content of which is hereby incorporated by reference herein).

According to a very recommended embodiment of the invention, the maximum roughness height Rt of the outer surface of the pipeline is advantageously less than 50 μm, preferably less than 45 μm, and preferentially less than 40 μm. The maximum roughness height Rt is defined as the sum of the height of the largest profile top and the depth of the largest profile valley of the roughness profile inside the test section (DIN EN ISO 4287).—It is within the framework of the invention that the, in the above mentioned, roughness values Ra as well as Rt are determined by a roughness measurement along the pipeline circumference. The pipeline advantageously rotates in the roughness measurement under a roughness measurement sensor that records the roughness profile.—The above mentioned roughness value or the roughness characteristics have proven themselves particular for the solution of the technical problem according to the invention.

It is recommended that the aluminum layer contains at least 85 wt %, preferably at least 90 wt %, preferentially at least 95 wt %, and very preferentially at least 98 wt % aluminum. It is thereby in the framework of the invention that the aluminum layer consists of an aluminum alloy with the same previously mentioned aluminum percentages. According to a particularly preferred embodiment of the invention, the aluminum layer consists of an aluminum or an aluminum alloy according to the standard EN 573-3 from July 2003 (series 1000 to 8000, the content of which is hereby incorporated by reference herein). It is recommended that the aluminum as well as the aluminum alloy of the aluminum layer contains at least one component, or at least one element, of the group “silicon, iron, copper, manganese, magnesium, chromium, nickel, zirconium, boron, bismuth, lead, cobalt, zinc, titanium, gallium, vanadium.” A very preferred embodiment variant of the invention is characterized by that the aluminum or the aluminum alloy of the aluminum layer contains silicon and iron and in addition preferably zinc and/or copper and/or manganese and/or magnesium and/or titanium, whereby the aluminum as well as the aluminum alloy contains at least 85 wt %, according to recommendation at least 90 wt %, preferentially at least 95 wt %, and particularly preferentially at least 99 wt % aluminum.

According to a particularly preferred embodiment of the invention, the aluminum as well as the aluminum alloy of the aluminum layer contains 0.05 to 0.22 wt % silicon and 0.05 to 0.27 wt % iron. Preferably, they contain in addition 0.02 to 0.09 wt % zinc. The aforementioned aluminum as well as the aforementioned aluminum alloy with the specified percentages of silicon and iron and zinc advantageously contains in addition 0.01 to 0.04 wt % copper and/or 0.01 to 0.04 wt % manganese and/or 0.01 to 0.04 wt % magnesium and/or 0.01 to 0.04 wt % titanium. According to recommendation, the aluminum as well as the aluminum alloy contains, in addition to the aluminum, exclusively silicon and iron as well as preferably zinc and advantageously copper and/or manganese and/or magnesium and/or titanium. Other components, each only in an amount up to 0.03 wt %, can be included according to the last mentioned embodiment variant.—The compounds of aluminum or aluminum alloy described in the preceding have in particular proven themselves with respect to the solution of the technical problem according to the invention. This embodiment or embodiments, on the one hand, result in a high corrosion resistance and, on the other, also in a high mechanical resistance of the pipeline as well as a surprisingly high bond strength of the bonds of the layers.

In particular, if the in the preceding described compounds are used, a particularly high bond strength of aluminum layer can be achieved. The invention is based on the recognition that the bond strength of the aluminum layer advantageously should be determined with a specific test method. For this, in a linear piece of the pipeline, or in an essentially linear piece of the pipeline, the outer layer (aluminum layer and aluminum oxide layer) is incised over the extent of the pipeline up to the outer surface of the metal tube/steel tube. The pipeline is subsequently bent in the region of the incision over 180° or approximately over 180°, so that the incision is located in the apex or the maximum of the bending semicircle. The bending radius is 7 to 9 mm for an outer diameter of the pipeline of 4 to 5.5 mm, in particular, the bending radius is 8 mm for an outer diameter of 4.75 mm. According to recommendation, the bending radius is between 11 and 14 mm for an outer diameter of the pipeline from 5.5 to 6.5 mm and is, in particular, 12 mm for an outer diameter of the pipeline of 6 mm. For an outer diameter of the pipeline from 6.5 to 8.5 mm the bending radius is advantageously 15 to 23 mm, in particular, it is 19 mm for an outer diameter of the pipeline of 8 mm. According to recommendation, the bending radius is 23 to 31 mm for an outer diameter of the pipeline from 8.5 to 12 mm, in particular 27 mm for an outer diameter of 10 mm.—According to a particularly preferred embodiment of the invention, the bending radius R is chosen according to the following formula as a function of the outside diameter pipeline x (R and×x values each in mm):

R(x)=0.121 x2+1.83x−3.44.

It is within the framework of the invention that the pipeline is suitable for the invention if test spalling of the outer layer in the region of the incision or at bending semicircle does not take place during the bending test. The composition of the aluminum layer is advantageously adjusted according to the specifications given in the above in such a way that a spalling of the outer layer does not occur in this bending test. A good bond strength of the outer layer as well as the aluminum layer results in a high corrosion resistance of the pipeline.

For the solution of the technical problem the invention also teaches a method for manufacturing a motor vehicle pipeline, whereby an aluminum layer is applied by a hot-dip process to the outer surface to a metal tube, preferably a steel tube, and whereby an aluminum oxide layer is created on the outer surface of the aluminum layer. The aluminum layer is directly applied to the uncoated outer surface of the metal tube/steel tube according to a first embodiment variant of the method according to the invention. According to a second variant of the method according to the invention, initially a nickel layer is applied to this uncoated outer surface of the metal tube/steel tube and the aluminum layer is then advantageously applied directly to the nickel layer. The nickel layer can thereby, according to an embodiment, be applied to the uncoated outer surface of a metal band/steel band, which metal band/steel band is rolled into a single-walled or double-walled metal tube/steel tube and the aluminum layer is subsequently directly applied to the nickel layer. One embodiment of the method according to the invention also includes the, in the above explained, applying of a copper layer to the uncoated outer surface of the metal tube/steel tube or a metal band/steel band that is then rolled into a single-walled or double-walled metal tube/steel tube.

It is within the framework of the invention that the cooling of the, by the hot-dip process applied, aluminum layer is carried out with the proviso that an aluminum oxide layer is produced with a thickness of 4 to 30 nm, preferably 5 to 25 nm, and particularly preferentially 6 to 20 nm. The aluminum reacts in the production of the aluminum oxide layer with the, in the respective atmosphere existing, oxygen into aluminum oxide AlxOy. The layer thickness of the aluminum oxide layer is thereby determined by the method parameters, in particular the temperature of the aluminum and the oxygen concentration of the atmosphere. It is within the framework of the invention that the temperature of the aluminum and/or the oxygen concentration of the atmosphere is adjusted in such a way that they yield the above mentioned layer thicknesses for the aluminum oxide layer.

The invention is based on the recognition that a motor vehicle pipeline according to the invention can be manufactured in a relatively simple and inexpensive way. Nevertheless, the motor vehicle pipeline has an excellent corrosion resistance. A very important advantage of the motor vehicle pipeline according to the invention is that the pipeline, contrary to a tube coated with plastic, can be used also at higher temperatures, namely in particular also at temperatures above the softening temperature of respective plastics. The plastic pipelines cannot be used at such temperatures. Furthermore, the motor vehicle pipeline according to the invention also stands out due to a surprisingly high mechanical resistance. In particular motor vehicle pipelines manufactured from double-walled tubes have proven themselves. Despite the relatively simple manufacturing method nevertheless significant advantages are achieved in comparison to other motor vehicle pipelines known from the state of the art. Due to the low manufacturing cost a motor vehicle pipeline according to the invention can also be manufactured relatively cost-effectively.

The invention is further explained in the following with the aid of an embodiment example: From a steel band that is on one side coated with copper and on the other side with nickel, a double-walled steel tube (double wall tube) is rolled and namely in such a way that the nickel layer is located on the outer surface of the double-walled tube. Advantageously, a soldering of the two tube walls takes place with the aid of the copper coating. The thickness of the nickel layer on the outside is preferably 0.5 to 1.5 μm. This double-walled nickel coated steel tube is subsequently coated within the framework of a hot-dip process with an aluminum coating. The thickness of the aluminum layer is thereby 30 to 200 μm. One lets the tube with the aluminum coating cool with the proviso that an aluminum oxide layer forms on the outside of the tube or on the outside of aluminum layer. The method is advantageously carried out in such a way that the thickness of the aluminum oxide layer is 4 to 30 nm, preferably 5 to 25 nm. The roundness of this pipeline is according to recommendation maximally 150 μm. The layer thickness variation of the outer layer is maximally 40 μm. It is recommended that the average roughness Ra of the outer surface of the pipeline is less than 6 μm. The maximum roughness height Rt of the outer surface of the pipeline is preferably less than 40 μm. According to recommendation, an aluminum ENAW-1070A according to EN 573-3 (2003) is used for the aluminum layer. The aluminum of the aluminum layer advantageously contains an aluminum fraction of at least 99.5 wt %, preferably 99.7 wt %. This aluminum contains according to recommendation 0.05 to 0.22 wt % silicon, 0.05 to 0.27 wt % iron, 0.02 to 0.09 wt % zinc, 0.01 to 0.04 wt % copper, 0.01 to 0.04 wt % manganese, 0.01 to 0.04 wt % magnesium, and 0.01 to 0.04 wt % titanium.

### BRIEF DESCRIPTION OF THE DRAWINGS

The invention is further explained in the following on the basis of a drawing that depicts an embodiment example. They show in a schematic representation:

FIG. 1 is a cross section through a motor vehicle pipeline according to the invention in a first embodiment;

FIG. 2 is the object according to FIG. 1 in a second embodiment; and

FIG. 3 is the motor vehicle pipeline according to the invention in the bending test.

### DETAILED DESCRIPTION OF THE ILLUSTRATED EMBODIMENTS

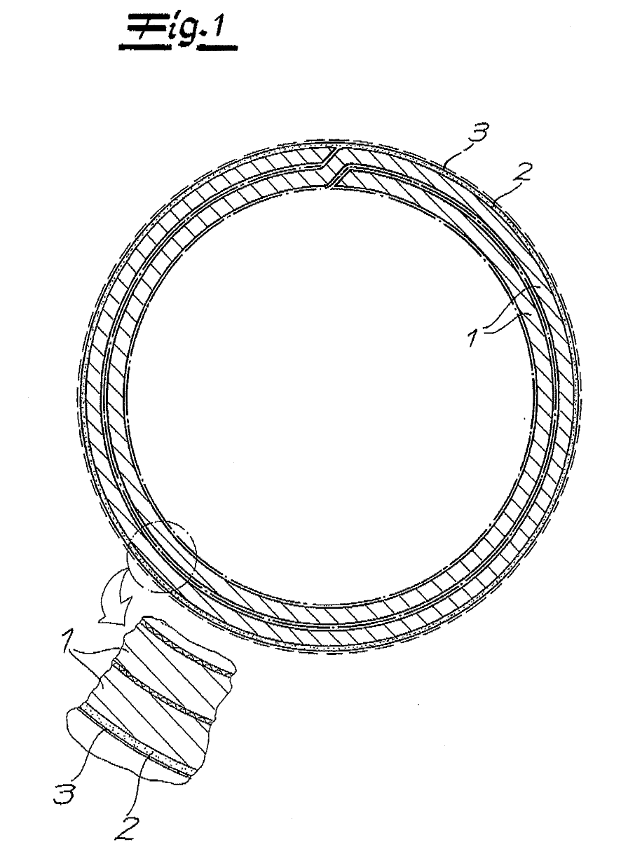

An aluminum layer 2 has been applied to the, initially uncoated, outer surface of a double-walled steel tube 1 in the first embodiment according to FIG. 1. The application of the aluminum layer 2 thereby advantageously takes place according to the hot-dip process. An aluminum oxide layer 3 that forms the outer surface of the motor vehicle pipeline is directly arranged on the aluminum layer 2.

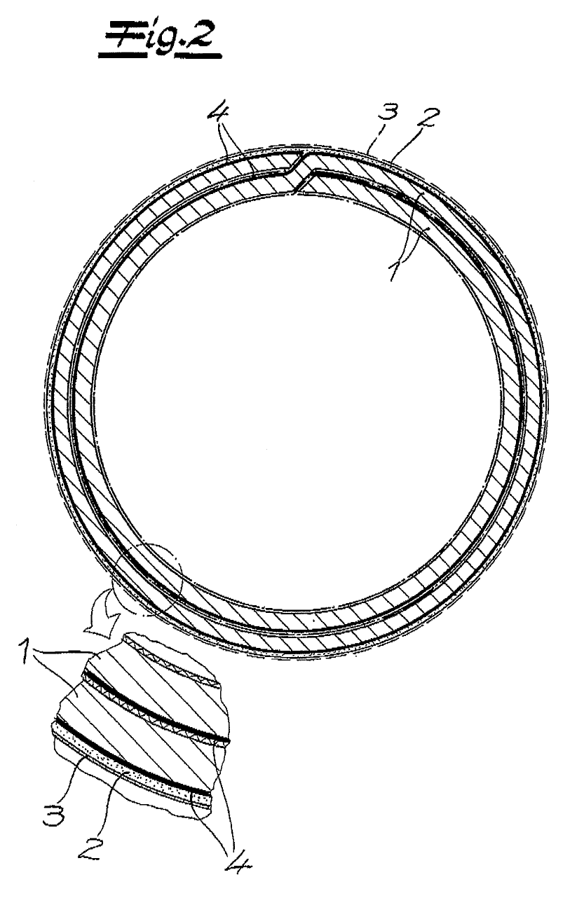

On the outer surface of the double-walled steel tube 1 initially a nickel layer 4 is applied in the second embodiment according to FIG. 2. The aluminum layer 2, which is also here advantageously applied with the hot-dip process, is arranged on this nickel layer 4. The aluminum oxide layer 3, which also in embodiment example according to FIG. 2 forms the outer surface of the motor vehicle pipeline, attaches on the outside to the aluminum layer 2. In the manufacturing of the double-walled steel tube 1 according to FIG. 2, a steel band coated with nickel is used on one side or surface which is then rolled into the double-walled steel tube 1. In this embodiment also still a, in FIG. 2 not shown, copper layer can be interposed between the outer surface of the steel tube 1 and the nickel layer 4.

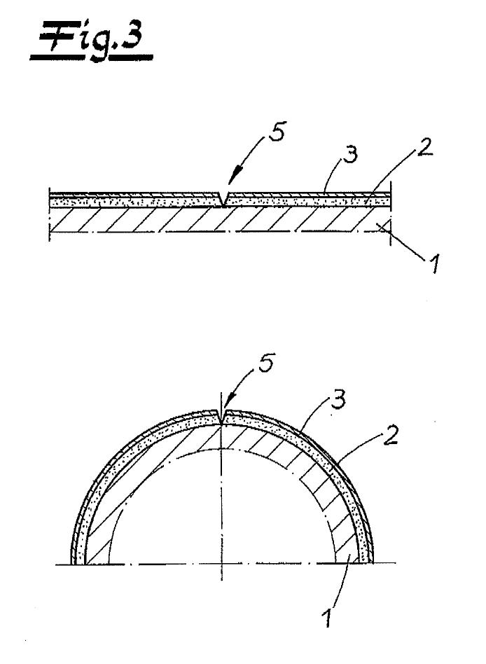

FIG. 3 illustrates a preferred bending test of the invention. A linear pipeline piece of a steel tube 1 is depicted in the upper part of FIG. 3. In the outer layer (aluminum layer 2 and aluminum oxide layer 3) an incision 5 is made over the circumference of the steel tube 1 that reaches exactly up to the outer surface of the steel tube 1. The steel tube 1 is subsequently bent 180°, as is shown in the lower part of FIG. 3. After the bending the incision 5 must be located at the apex or the maximum of the bending semicircle. The bending radius is thereby advantageously chosen as a function of the outside diameter of the pipeline. This was specified in the above in more detail. In the lower part of FIG. 3 it can be seen that spallings of the outer layer of the steel tube 1 have not taken place and this steel tube 1 is thus suitable for use according to the invention in an advantageous manner.

1. A motor vehicle pipeline comprising a metal tube, with an aluminum layer (2) on the outer surface of the metal tube (2) with an aluminum oxide layer (3) present on the outer surface of the aluminum layer (2), and said aluminum oxide layer (3) is the outer layer of the motor vehicle pipeline.

2. A motor vehicle pipeline according to claim 1, whereby said metal tube is a steel tube and a nickel layer (4) is arranged between the outer surface of the metal tube and the aluminum layer (2).

3. A motor vehicle pipeline according to claim 1 whereby a copper layer is arranged between the outer surface of the metal tube and the aluminum layer (2), whereby the thickness of the copper layer is 50 to 300 nm, preferably 50 to 200 nm, very preferentially 50 to 150 nm, and particularly preferentially 70 to 130 nm.

4. A motor vehicle pipeline according to claim 2, whereby a copper layer is arranged between the outer surface of the metal tube and the aluminum layer (2), whereby the thickness of the copper layer is 50 to 300 nm, preferably 50 to 200 nm, very preferentially 50 to 150 nm, and particularly preferentially 70 to 130 nm.

5. A motor vehicle pipeline according to claim 4, whereby the nickel layer (4) is arranged between the copper layer and the aluminum layer (2) and borders directly to the copper layer on one side and to the aluminum layer (2) on the other side, and the thickness of the nickel layer is 0.2 to 50 μm, preferably 0.2 to 10 μm, and preferentially 0.2 to 5 μm.

6. A motor vehicle pipeline according to any one of claims 1 to 5, whereby the thickness of the aluminum layer (2) is 10 to 200 μm, preferably 20 to 180 μm, and preferentially 25 to 150 μm.

7. A motor vehicle pipeline according to claim 6, whereby the thickness of the aluminum oxide (3) is 4 to 30 nm, preferably 5 to 25 nm, and preferentially 6 to 20 nm.

8. A motor vehicle pipeline according to claim 1, whereby the roundness of the outer contour of the pipeline is maximally 500 μm, preferably maximally 400 μm, preferentially maximally 300 μm, and particularly preferentially maximally 200 μm.

9. A motor vehicle pipeline according to claim 1, whereby the variation of the layer thickness of the outer layer is maximally 100 μm, preferably maximally 80 μm, preferentially maximally 60 μm, very preferentially maximally 50 μm, and particularly preferentially maximally 40 μm.

10. A motor vehicle pipeline according to claim 1, whereby the average roughness Ra of the outer surface of the pipeline is less than 8 μm, preferably less than 7 μm, preferentially less than 6.8 μm, very preferentially less than 6.5 μm, and particularly preferentially less than 6 μm.

11. A motor vehicle pipeline according to claim 1, whereby the maximum roughness height Rₜ of the outer surface of the pipeline is less than 50 μm, preferably less than 45 μm, and preferentially less than 40 μm.

12. A motor vehicle pipeline according to claim 1, whereby the aluminum layer (2) contains at least 95 wt % aluminum, preferably at least 98 wt % aluminum as well as silicon and/or iron.

13. A motor vehicle pipeline according to claim 12, whereby the aluminum layer (2) contains in addition copper and/or zinc as well as preferably manganese and/or magnesium.

14. A method for manufacturing a motor vehicle pipeline, the steps comprising providing a metal tube, preferably a steel tube, applying an aluminum layer (2) by a hot-dip process on the outer surface of said metal tube cooling the aluminum layer applied with the hot-dip process with the proviso that, on the outer surface of the aluminum layer, an aluminum oxide layer results with a thickness of 4 to 30 nm, preferably 5 to 25 nm, and preferentially 6 to 20 nm.
